(19) United States
(12) Patent Application Publication
(10) Pub. No.: US 2007/0237558 A1
(43) Pub. Date: Oct. 11, 2007

(54) IMAGE FORMING APPARATUS, IMAGE FORMING METHOD, SHEET CONVEYING APPARATUS, AND SHEET CONVEYING METHOD

(75) Inventor: Takashi NAKANISHI, Abiko-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/691,526

(22) Filed: Mar. 27, 2007

(30) Foreign Application Priority Data
Apr. 10, 2006 (JP) 2006-108043

(51) Int. Cl. G03G 15/00

(52) U.S. Cl. 399/394

(57) ABSTRACT

An image forming apparatus which make it possible to acquire phase information related to phases of a recording sheet being conveyed using an inexpensive structure without increases in size. An image on a recording sheet P being conveyed is formed. The recording sheet P is irradiated with a laser beam. A speckle generated by the irradiation of the recording sheet P with the laser beam is scanned. Phase information about the recording sheet P is acquired based on a speckle 500 read this time and a speckle 600 read after a lapse of t seconds. Position of the image to be formed is adjusted based on the acquired phase information.

### BACKGROUND OF THE INVENTION

1. Field of the Invention

The present invention relates to an image forming apparatus, image forming method, sheet conveying apparatus, and sheet conveying method, and more particularly, to an image forming apparatus which performs an image forming operation to form images on sheets being conveyed as well as to an image forming method, sheet conveying apparatus, and sheet conveying method.

2. Description of the Related Art

A digital multifunction apparatus as an image forming apparatus is equipped with a sheet feeding section which feeds recording sheets (sheets) of a predetermined size sheet by sheet. The recording sheet fed by the sheet feeding section is conveyed to a registration section which brings the recording sheet into registration with images formed by an image forming section via a conveying path (a path) for the recording sheet being conveyed.

In a sheet feeding section, multiple feed of the recording sheets can sometimes occur. There has been proposed an image forming apparatus which determines a condition of multiple feed of recording sheets, and forms an image by shifting an image transfer position to the uppermost one of the multiple feed of recording sheets at a time of creation of a latent image when it is determined that the multiple feed of recording sheets occurs (see, for example, Japanese Laid-Open Patent Publication (Kokai) No. 2003-295727). According to this technique, even if the recording papers are multi-fed due to a failure of the sheet feeding section to separate the recording sheets, it is possible to continue an execution of a job without making it a jam as multiple feed.

Also, there has been proposed an image forming apparatus which detects the time period (a timing) that elapses after a recording sheet is fed using a recording sheet sensor installed on a conveying path (see, for example, Japanese Laid-Open Patent Publication (Kokai) No. 2000-159357). This technique regards any delay in the detected time in relation to a predetermined time to be attributable to skewing (rotating) of a recording sheet caused by wear, material degradation, or the like of rollers installed in the sheet feeding section and the conveying path. Thus, this technique makes it possible to determine conveying forces of the sheet feeding section and the conveying path, especially, to determine a replacement time of the rollers, based on the delay in the detected time.

However, with the conventional image forming apparatus described above, to detect multiple feed of recording sheets, it is necessary to install at least two sensors, including a sensor which detects the front end of the recording sheet in the conveying direction and a sensor which detects both ends of the recording sheet in the direction orthogonal to the conveying direction. This increases the size of the image forming apparatus.

The conventional image forming apparatus can detect skewing or rotating of a recording sheet indirectly. However, since the skewing or rotating of a recording sheet are attributable to degradation or changes of roller surfaces, if a recording sheet prone to paper dust is used in particular, conditions of the roller surfaces are changed by the paper dust, making it difficult to predict an extent of skewing or rotating of the recording sheet being conveyed. Thus, there is a demand to detect skewing or rotating of a recording sheet directly instead of the above technique.

To detect skewing of a recording sheet directly, it is necessary to detect end movements of the recording sheet with respect to the conveying direction and analyze the detected end movements using a high-performance processor. Thus, this technique not only increases the costs of the image forming apparatus by the amount corresponding to the performance improvement of the processor, but also increases the size of the image forming apparatus by the amount corresponding to the space required to install the processor.

### SUMMARY OF THE INVENTION

The present invention provides an image forming apparatus, image forming method, sheet conveying apparatus, and sheet conveying method which make it possible to acquire phase information related to phases of a recording sheet being conveyed using an inexpensive structure without increases in size.

In a first aspect of the present invention, there is provided an image forming apparatus comprising an image forming unit adapted to form an image on a sheet being conveyed, a light irradiation unit adapted to irradiate the sheet with a laser beam, a scanning unit adapted to scan a pattern image generated by the irradiation of the sheet with the laser beam, a phase information acquisition unit adapted to acquire phase information about the sheet based on the pattern image read by the scanning unit and the pattern image read after a lapse of a predetermined time, and the image forming unit adjusts position of the image to be formed based on the phase information acquired by the phase information acquisition unit.

In a second aspect of the present invention, there is provided an image forming apparatus adapted to perform an image forming operation to form images on a sheet being conveyed, comprising a light irradiation unit adapted to irradiate the sheet with a laser beam, a light intensity detection unit adapted to detect scattered light intensity of the laser beam reflected by at least part of area on a surface of the sheet, a light intensity distribution information acquisition unit adapted to acquire light intensity distribution information about distribution of the detected light intensity in the at least part of area, and a phase information acquisition unit adapted to acquire phase information about phases of the sheet based on the light intensity distribution information.

The phase information acquisition unit can acquire displacement information about displacement of the sheet based on changes in the light intensity distribution information.

The image forming apparatus can comprise an adjustment unit adapted to adjust a forming position of an image to be formed on the sheet based on the acquired displacement information about the sheet.

The adjustment unit can perform at least one of correction of the forming position of the image and rotation of the image based on a position to which the sheet is transported to adjust the forming position of the image.

The image forming apparatus can comprise an adjustment unit adapted to adjust a conveying direction of the sheet based on the acquired displacement information about the sheet.

In a third aspect of the present invention, there is provided an image forming method for performing an image forming operation to form images on a sheet being conveyed, comprising a light irradiation step of irradiating the sheet with a laser beam, a light intensity detection step of detecting scattered light intensity of the laser beam reflected by at least part of area on a surface of the sheet, a light intensity distribution information acquisition step of acquiring light intensity distribution information about distribution of the detected light intensity in the at least part of area, and a phase information acquisition step of acquiring phase information about phases of the sheet based on the light intensity distribution information.

The phase information acquisition step can acquire displacement information about displacement of the sheet based on changes in the light intensity distribution information.

The image forming method can comprise an adjustment step of adjusting a forming position of an image to be formed on the sheet based on the acquired displacement information about the sheet.

The adjustment step can perform at least one of correction of the forming position of the image and rotation of the image based on a position to which the sheet is conveyed to adjust the forming position of the image.

The image forming method can comprise an adjustment step of adjusting a conveying direction of the sheet based on the acquired displacement information about the sheet.

In a fourth aspect of the present invention, there is provided a sheet conveying apparatus adapted to convey a sheet, comprising a light irradiation unit adapted to irradiate the sheet with a laser beam, a light intensity detection unit adapted to detect scattered light intensity of the laser beam reflected by at least part of area on a surface of the sheet, a light intensity distribution information acquisition unit adapted to acquire light intensity distribution information about distribution of the detected light intensity in the at least part of area, and a phase information acquisition unit adapted to acquire phase information about phases of the sheet based on the light intensity distribution information.

In a fifth aspect of the present invention, there is provided a sheet conveying method for conveying a sheet, comprising a light irradiation step of irradiating the sheet with a laser beam a light intensity detection step of detecting scattered light intensity of the laser beam reflected by at least part of area on a surface of the sheet, a light intensity distribution information acquisition step of acquiring light intensity distribution information about distribution of the detected light intensity in the at least part of area, and a phase information acquisition step of acquiring phase information about phases of the sheet based on the light intensity distribution information.

According to the present invention, an image on a sheet being conveyed is formed, the sheet is irradiated with a laser beam, a pattern image generated by the irradiation of the sheet with the laser beam is scanned, phase information about the sheet is acquired based on the pattern image read this time and the pattern image read after a lapse of a predetermined time, and position of the image to be formed is adjusted based on the acquired phase information. This makes it possible to acquire the phase information (multiple feed, skew, and rotation) related to the recording sheet being conveyed using an inexpensive structure without increases in size.

The above and other objects, features, and advantages of the invention will become more apparent from the following detailed description taken in conjunction with the accompanying drawings.

### BRIEF DESCRIPTION OF THE DRAWINGS

FIG. 1 is a sectional view schematically showing a configuration of a copier as an image forming apparatus according to an embodiment of the present invention.

FIG. 2 is a block diagram schematically showing a configuration of a sheet phase information acquisition device including a CCD sensor shown in FIG. 1.

FIG. 3 is an enlarged sectional view of part of FIG. 2.

FIG. 4 is a diagram showing light intensity on an image forming plane (XY plane) of a CCD shown in FIG. 3.

FIG. 5 is a diagram showing a first example of an image on a recording sheet picked up by the CCD shown in FIG. 3.

FIG. 6 is a diagram showing a second example of an image (speckle) on the recording sheet picked up by the CCD shown in FIG. 3.

FIG. 7 is a flowchart of an image forming operation performed by the copier shown in FIG. 1.

FIG. 8A is a diagram showing a relationship between image forming position and actual transfer position on a recording sheet.

FIG. 8B is a diagram showing image forming position after adjustment of the image forming position shown in FIG. 8A.

FIG. 9 is a top view schematically showing a sheet feeding section to illustrate a variation of the embodiment according to the present invention.

### DETAILED DESCRIPTION OF THE PREFERRED EMBODIMENTS

The present invention will now be described in detail with reference to the drawings showing preferred embodiments thereof.

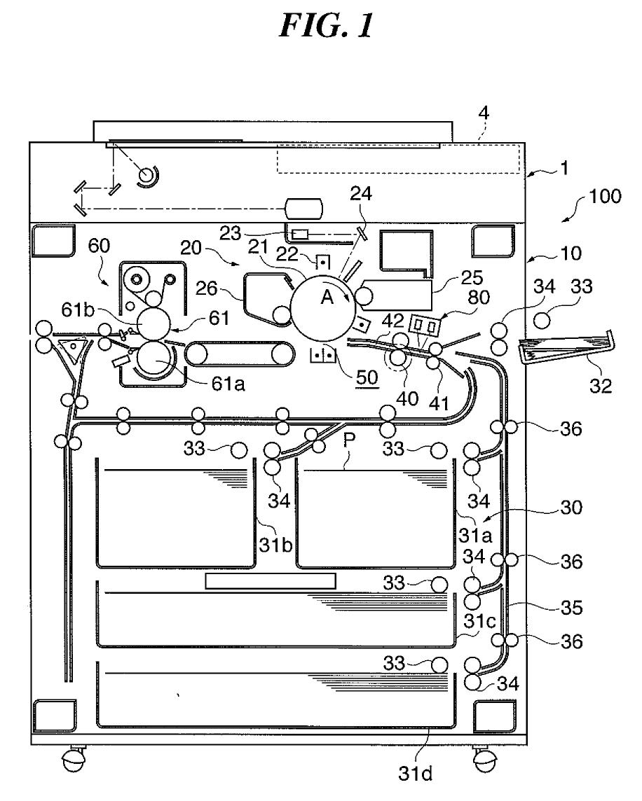

FIG. 1 is a sectional view schematically showing a configuration of a copier as an image forming apparatus according to an embodiment of the present invention.

In FIG. 1, a digital monochrome copier 100 is comprised of a scanner section 1 which scans an original image and acquires monochrome image information and a printer section 10 which forms an image corresponding to the image information from the scanner section 1 on recording sheet as a sheet.

The scanner section 1 has an operating section 4 which is equipped with a display screen. The operating section 4 allows the user to set the number of copies, select recording sheets as copy papers, and select a sheet discharging method between face up discharge and face down discharge. The display screen of the operating section 4 displays information indicative of an error such as a paper jam occurring in the copier 100.

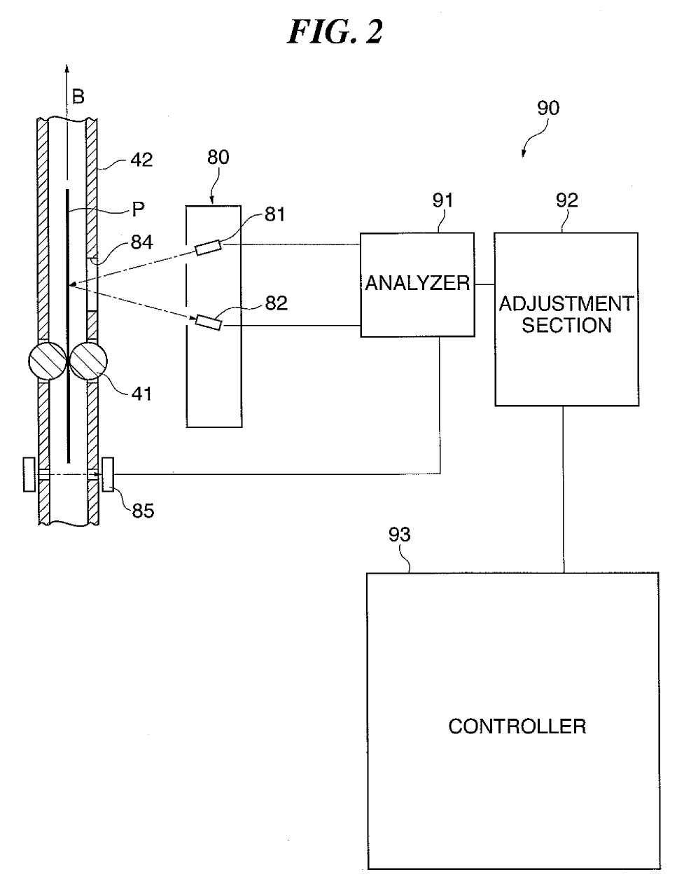

The printer section 10 has an image forming section 20, a sheet feeding section 30, a fixing section 60, and a controller 93 (which is not shown in FIG. 1, but will be described with reference to FIG. 2). The image forming section 20, the sheet feeding section 30, and the fixing section 60 are controlled by the controller 93, respectively.

Various parts of the copier 100 will be described in detail below.

A photosensitive drum 21 as an image carrier, is rotatably and pivotally supported at the center of the image forming section 20 and is driven to rotate in the direction of arrow A in FIG. 1 by a drive motor, not shown.

Also, a primary charger 22, an exposing section 23, a reflecting mirror 24, a developing device 25, and a cleaning device 26 are arranged in the rotation direction of the photosensitive drum 21, facing its outer peripheral surface.

The primary charger 22 charges the photosensitive drum 21 so that a surface of the photosensitive drum 21 is charged uniformly. Next, the exposing section 23 exposes the photosensitive drum 21 and forms electrostatic latent images on its surface by irradiating a laser beam whose wave length has been modulated in accordance with the image information (an image signal) received from the scanner section 1 via the reflecting mirror 24. The developing device 25 contains black (Bk) toner (developer) and develops the electrostatic latent images as a monochrome visible image using the toner. An image forming operation is performed by the image forming section 20 through the processes described above. At a transfer position 50 in FIG. 1, the monochrome visible image is transferred to a recording sheet P conveyed by the sheet feeding section 30 as a sheet material. The cleaning device 26 is placed between the transfer position 50 and primary charger 22, facing the photosensitive drum 21. The cleaning device 26 cleans the surface of the photosensitive drum 21 by scraping residual toner remaining on the photosensitive drum 21 after the transfer of the visible image.

The sheet feeding section 30 feeds the recording sheets contained in paper feed stages toward the transfer position 50 sheet by sheet. The paper feed stages include cassettes 31a, 31b, 31c, and 31d, and a manual feed tray 32. Also, to feed recording sheets sheet by sheet from each of the paper feed stages, the sheet feeding section 30 has pick-up rollers 33 and a plurality of sheet feeding roller pairs 34. Even if a plurality of recording sheets are pulled out by each of the pick-up rollers 33, each of the paper feed roller pairs 34 reliably separates the recording sheets from one another and feeds a recording sheet P. The sheet feeding section 30 has a sheet feed guide 35 which constitutes a conveying path used to convey the recording sheet P from the cassettes 31a, 31c, and 31d as well as pull-off roller pairs 36 installed in recesses in the sheet feed guide 35. The pull-off roller pairs 36 convey the recording sheet P fed into the sheet feed guide 35 toward the transfer position 50. Similarly, a recording sheet P from the cassette 31b is conveyed by the pull-off roller pairs through the sheet feed guide toward the transfer position 50.

The sheet feeding section 30 has registration roller pairs (hereinafter referred to as “registration roller”) 40 and a pre-registration roller 41 which are disposed in recesses in a sheet feed guide 42 of the sheet feeding section 30. Upstream of the transfer position 50 along the conveying direction, the registration roller 40 make timing adjustments needed to feed the recording sheet P to the transfer position 50 in synchronization with timing of image formation performed by the image forming section 20. Furthermore, upstream of the transfer position 50 along the conveying direction, the sheet feeding section 30 has a CCD sensor 80 (FIG. 2) disposed between the registration roller 40 and pre-registration roller 41 so as to face the sheet feed guide 42, for example, as shown in FIG. 1.

The visible image formed by the image forming section 20 is transferred to the recording sheet P fed to the transfer position 50 from the registration roller 40.

The fixing section 60 has a fixing roller pair 61 composed of a fixing roller 61a heated by a heat source and a fixing roller 61b which can press the fixing roller 61a. The fixing section 60 performs a fixing operation to fix a transferred image on the surface of the recording sheet P. After going through the fixing operation by the fixing section 60, the recording sheet P is discharged out of the copier 100.

FIG. 2 is a block diagram schematically showing a configuration of a sheet phase information acquisition device 90 including the CCD sensor 80 shown in FIG. 1. FIG. 2 also shows a cross section of part of the sheet feed guide 42 of the sheet feeding section 30.

In FIG. 2, the sheet phase information acquisition device 90 has the CCD sensor 80 which photographs the recording sheet P transported in the direction of arrow B by the pull-off roller pairs 36 of the sheet feeding section 30, an analyzing section 91 connected to the CCD sensor 80, an adjustment section 92 connected to the analyzing section 91, and the controller 93 connected to the adjustment section 92. The controller 93 controls the entire copier 100 including the sheet phase information acquisition device 90.

The CCD sensor 80 is composed of a laser diode (hereinafter referred to simply as the “LD”) 81 which irradiates a laser beam to the sheet feed guide 42 and a photoelectric element 82 which receives light from the direction of the sheet feed guide 42 and converts the light into an electrical signal.

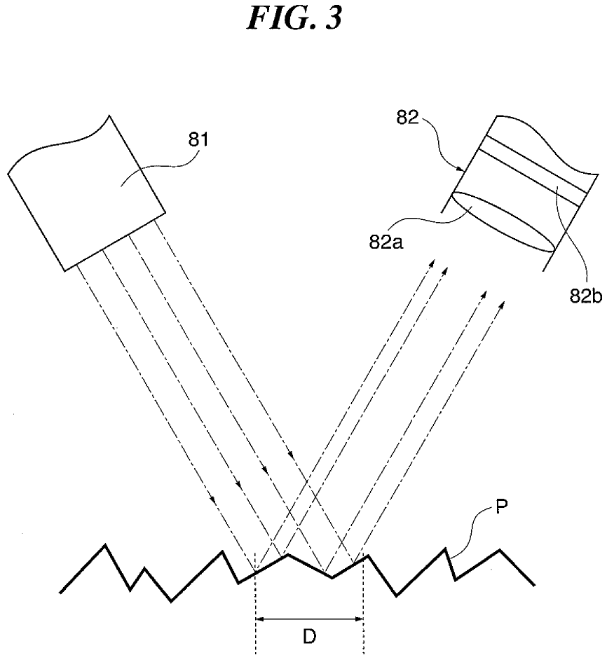

The LD 81 irradiates the laser beam such that the laser beam passes through an irradiation hole 84 formed in the sheet feed guide 42. Consequently, the recording sheet P being conveyed along the sheet feed guide 42 is also irradiated with the laser beam. The position of an irradiated surface is adjusted such that a spot diameter (diameter D shown in FIG. 3) of the laser beam irradiated from the LD 81 is, for example, 5 mm on the surface of the recording sheet P. Preferably, a lens or the like is used to enlarge the spot diameter. The shape of the spot diameter is not limited to a circular shape, and may be, for example, an approximately elliptical shape.

The photoelectric element 82 is composed of a lens 82a which receives the beam reflected by the recording sheet P and a CCD 82b which has an image forming plane on which light from the lens 82a forms an optical image (FIG. 3).

Thus, the CCD sensor 80 shown in FIG. 2 functions as an image pickup device which photographs a subject located in the direction of the sheet feed guide 42 and thereby acquires the optical image formed in the image forming plane of the CCD 82b as an electrical signal corresponding to light intensity.

In FIG. 2, the analyzing section 91 acquires light intensity distribution information about the distribution of light intensity in the optical image acquired by the CCD 82b. The adjustment section 92 acquires phase information about phases of the recording sheet P based on the light intensity distribution information acquired by the analyzing section 91. The acquired information is also inputted in the controller 93.

As shown in FIG. 2, a sensor 85 which detects the front end of the recording sheet P passing through the sheet feed guide 42 is installed upstream of the pre-registration roller 41 along the conveying direction. The sensor 85 is connected to the analyzing section 91 and outputs an ON signal to indicate passage of the front end of the recording sheet P. The analyzing section 91 activates the CCD sensor 80 based on the ON signal from the sensor 85.

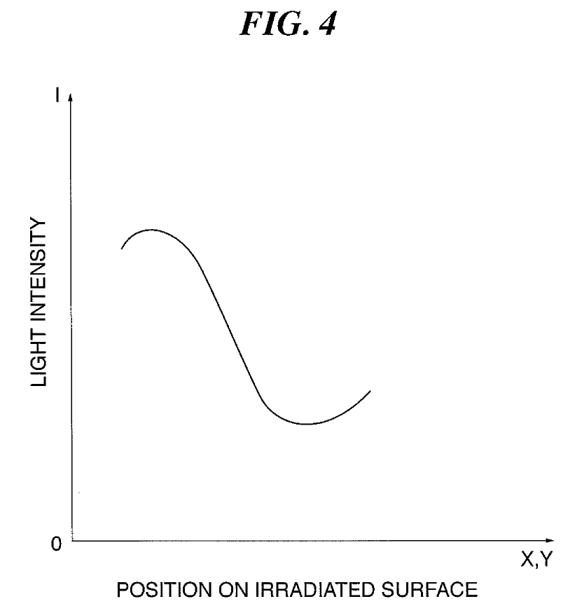

FIG. 3 is an enlarged sectional view of part of FIG. 2. FIG. 4 is a diagram showing light intensity on part of an optical image formed on an image forming plane of the CCD 82b shown in FIG. 3.

As shown in FIG. 3, a large number of microscopic asperities are formed on the surface of the recording sheet P. They have random patterns (in terms of depth and spacing). The laser beam from the LD 81 is scattered according to conditions of the asperities when reflected by the surface of the recording sheet P. Since the optical path length of the scattered light from the irradiated surface irradiated with the laser beam to the image forming plane (XY plane) of the CCD 82b varies, a light intensity I of the scattered light is reinforced or weakened (optical interference) according to the optical path as shown in FIG. 4. The CCD 82b picks up the optical image subjected to the optical interference as an image on the irradiated surface of the recording sheet P and inputs the image in the analyzing section 91.

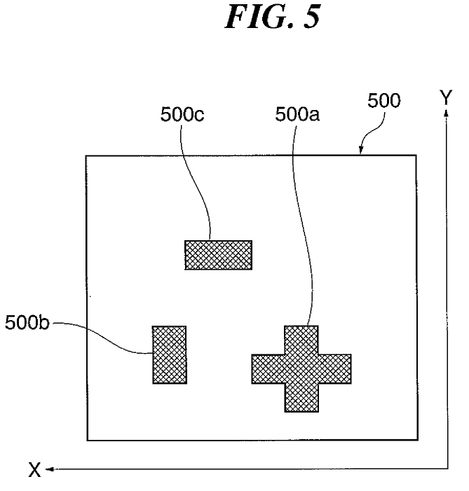

FIG. 5 is a diagram showing a first example of an image on the recording sheet P picked up by the CCD 82b shown in FIG. 3. X and Y in FIG. 5 correspond to orthogonal coordinates which define the image forming plane of the CCD 82b.

An image 500 (hereinafter referred to simply as a “speckle”) made up of a speckle pattern in FIG. 5 is an image on the recording sheet P picked up by the CCD 82b. The speckle pattern in the speckle 500 represents the light intensity I of scattered light of a laser beam subjected to optical interference, i.e., conditions of asperities on the surface of the recording sheet P as described above. Specifically, when the asperities on the recording sheet P are coarse, scattered light received from concave parts (shadowed parts) adjacent to convex parts becomes dark. The parts where the scattered light is dark correspond to those parts of the speckle 500 in FIG. 5 in which speckle patterns are pale in color. On the other hand, Those parts of the speckle pattern in FIG. 5 which are deep in color—i.e., local patterns 500a, 500b, and 500c—correspond to the parts where the scattered light is bright.

Thus, the speckle 500 in FIG. 5 represent conditions of asperities unique to the surface of the recording sheet P by light intensity distribution of scattered light.

An analysis of the speckle 500 conducted by the analyzing section 91 in FIG. 2 will be described below.

The analyzing section 91 is configured to acquire information (light intensity distribution information) unique to the speckle 500 as numeric values by analyzing the speckle 500 as follows.

Specifically, first the analyzing section 91 calculates an average light intensity <I> of all the pixels, for example, in an N-pixel CCD 82b using the following formula 1 below, where In is the value of light intensity of each pixel.

$$< I >= \frac{1}{N} {\sum }_{N} {I}_{n} \qquad [ Formula 1 ]$$

Next, using the following formula 2, the analyzing section 91 calculates a contrast ratio (hereinafter referred to as “speckle contrast”) Sc which represents the magnitude of brightness difference in the entire speckle pattern of the speckle 500 using the value of the average light intensity <I>. Incidentally, A in the formula 2 is a predetermined constant.

$$Sc = \frac{A \times \frac{1}{N} {\sum }_{N} \vert < I > - {I}_{n} \vert}{< I >} \qquad [ Formula 2 ]$$

The value of the speckle contrast Sc thus calculated is information unique to the speckle 500, representing surface conditions of the recording sheet P.

Information unique to the speckle 500 is not limited to the speckle contrast Sc, and includes any numeric value that can be acquired through image analysis of the speckle 500. In the present embodiment, in addition to the speckle contrast Sc, image frequency F is acquired as information unique to the speckle 500. The value of the image frequency F, which treats the brightness difference in the speckle pattern of the speckle 500 as a cycle, can be calculated as a Fourier transform of the light intensity of each pixel.

Now, description will be given of how the adjustment section 92 in FIG. 2 acquires phase information about the recording sheet P.

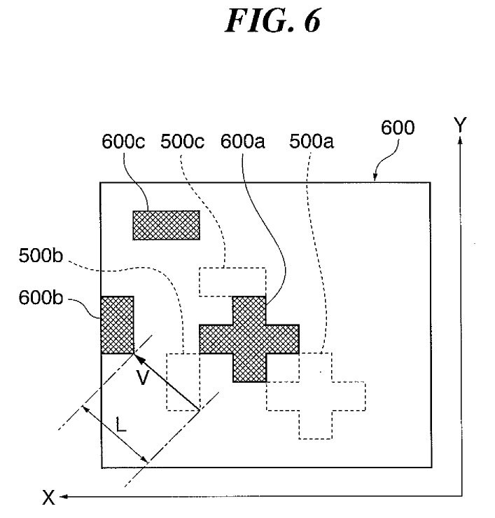

FIG. 6 is a diagram showing a second example of an image (speckle) on the recording sheet P picked up by the CCD 82b shown in FIG. 3. X and Y in FIG. 6 corresponds to orthogonal coordinates which define the image forming plane of the CCD 82b while the Y direction corresponds to the conveying direction in which the recording sheet P is conveyed by the sheet feeding section 30.

FIG. 6 shows a speckle 600 which is picked up when t seconds has elapsed after the speckle 500 in FIG. 5 was picked up by the CCD 82b. The broken lines in FIG. 6 represent the speckle 500 when FIG. 5 and FIG. 6 are superimposed such as to coincide in the image forming plane of the CCD 82b.

As shown in FIG. 6, the speckle pattern of the speckle 600 includes local patterns 600a, 600b, and 600c which are deep in color. The local patterns 600a, 600b, and 600c coincide in shape with the local patterns 500a, 500b, and 500c of the speckle 500, respectively. Consequently, the adjustment section 92 determines that the recording sheet P containing the speckle 600 and the recording sheet P containing the speckle 500 are identical. The adjustment section 92 may determine the identity of the speckles 500 and 600 by comparing at least one of the speckle contrast Sc and image frequency F between the speckles 500 and 600 acquired in sequence.

Furthermore, by comparing the speckles 500 and 600 determined to be identical, the adjustment section 92 finds a movement vector indicated by arrow V in FIG. 6 as phase information about the recording sheet P.

First, the adjustment section 92 acquires a value of moving distance L along the moving direction of the recording sheet P. Next, the adjustment section 92 calculates the value of velocity v of the recording sheet P by dividing the value of moving distance L by a time interval t between acquisitions of the speckles 500 and 600 (v=L/t). As a result, the adjustment section 92 can acquire the movement vector (direction and velocity) of the recording sheet P.

Next, the adjustment section 92 acquires displacement information about displacements of the recording sheet P in the X and Y directions based on the movement vector. Specifically, the adjustment section 92 calculates velocities vx and vy of the recording sheet P in the X and Y directions and a rotation angle • of the recording sheet P with respect to the conveying direction (Y direction).

As described above in detail, the sheet phase information acquisition device 90 in FIG. 2 can acquire phase information about conveyed recording sheet P by only acquiring and analyzing speckles on the recording sheet P using a simple and inexpensive configuration. Therefore, it is possible to easily detect skewing and rotating of the recording sheet P. Also, if local patterns differ among multiple speckles acquired in sequence, it is possible to determine that double feed of the recording sheet P has occurred.

Also, since a small CCD sensor 80 is good enough for the sheet phase information acquisition device 90, the CCD sensor 80 can be incorporated into an image forming apparatus such as a conventional copier without increases in the size of the apparatus and without layout constraints.

In the present embodiment, the image forming operation of the image forming section 20 is controlled using the phase information about the recording sheet P acquired as described above. This is described below.

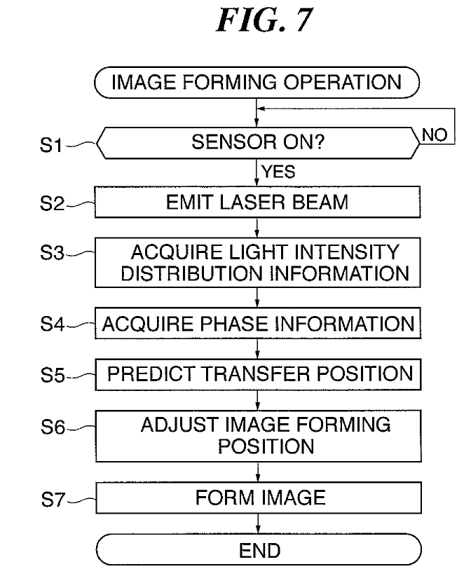

FIG. 7 is a flowchart of an image forming operation performed by the copier 100 shown in FIG. 1. This process is performed with the controller 93 in FIG. 2 controlling various parts of the copier 100.

In FIG. 7, first the sensor 85 installed upstream of the pre-registration roller 41 along the conveying direction detects the front end of the recording sheet P and outputs an ON signal to the analyzing section 91 (YES to step S1). Consequently, the analyzing section 91 activates the CCD sensor 80. In response to this, the CCD sensor 80 emits a laser beam from the LD 81 and photographs the irradiated surface in sequence using the CCD 82b (step S2).

Meanwhile, the analyzing section 91 calculates the values of speckle contrast Sc and image frequency F of the speckles as light intensity distribution information by analyzing the images, i.e., the speckles, photographed by the CCD 82b (step S3). Also, the adjustment section 92 calculates the values of the velocities vx and vy of the recording sheet P and the rotation angle θ of the recording sheet P with respect to the conveying direction (Y direction) based on the movement vectors acquired from multiple speckles, and thereby acquires the values of the velocities vx, vy and the rotation angle θ as phase information about the recording sheet P (step S4).

In step S5, the adjustment section 92 predicts condition of the transported recording sheet P when it reaches the transfer position 50, i.e., it predicts actual transfer position.

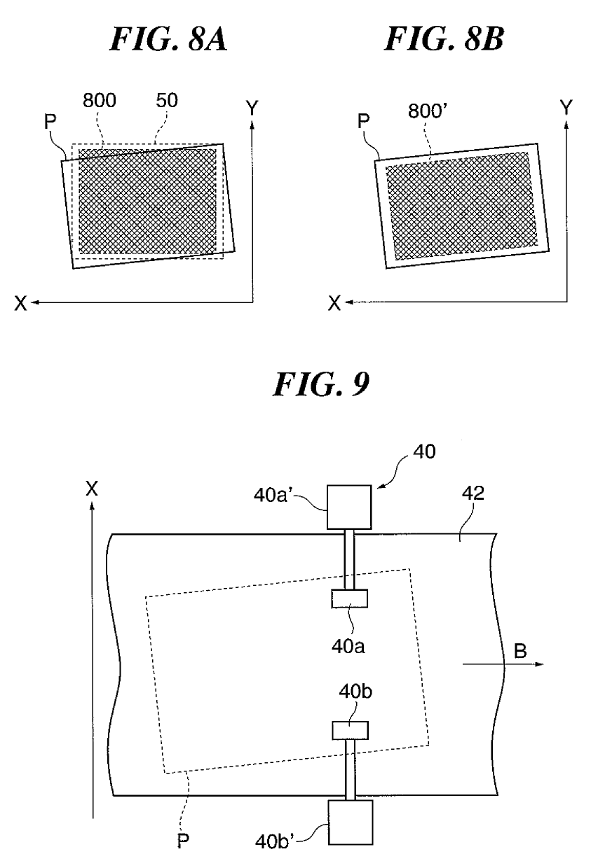

As a specific example, suppose conveying distance of the recording sheet P from speckle acquisition position to transfer position 50 is 100 mm and the recording sheet P is skewed with a vx velocity of 1 mm/second and a vy velocity of 100 mm/second (the rotation angle θ is less than 1°) (where the velocities have been acquired in the step S4). In this case, the recording sheet P approaches in the vicinity of the transfer position 50 after 1 second, but actually deviates 1 mm from the transfer position 50 in a direction (X direction) orthogonal to the conveying direction. Consequently, if the visible image formed by the image forming section 20 is transferred directly to the recording sheet P, misregistration occurs between image forming position 800 which allows for margins of the recording sheet P in relation to the transfer position 50 and actual transfer position on the recording sheet P, as shown in FIG. 8A.

In the present embodiment, based on the actual transfer position predicted in the step S5, the image forming position 800 in FIG. 5A is corrected to image forming position 800′ in FIG. 8B (step S6). In the specific example described above, the image forming section 20 rotates the visible image to be formed on the photosensitive drum 21 in accordance with the rotation angle θ and shifts the position (writing position) on the photosensitive drum 21 at which the visible image will be formed by 1 mm in the X direction. Subsequently, the image forming section 20 forms the visible image with the actual writing position on the photosensitive drum 21 adjusted (step S7). This makes it possible to avoid misregistration between the image forming position of the visible image and recording sheet P at the transfer position 50 mainly in the X direction.

The adjustment section 92 compares the value of a preset conveying velocity of the recording sheet P and the value of vy velocity acquired in the step S4. Based on the results of comparison, the adjustment section 92 adjusts the timing of when the registration roller 40 feeds the recording sheet P to the transfer position 50 or adjusts writing position at which the image forming section 20 starts forming the visible image. This makes it possible to correct conveying delays caused by skew feed of the recording sheet. P, and consequently avoid misregistration mainly in the Y direction.

According to the procedures in FIG. 7, the adjustment section 92 acquires the phase information about the recording sheet P (step S4) from the speckles acquired by the CCD sensor 80 in FIG. 2, predicts the actual transfer position (step S5), and corrects the image forming position 800 to the image forming position 8001 (step S6). This makes it possible to avoid misregistration and transfer the visible image to the recording sheet P properly.

Although in the step S6 in FIG. 7, the writing position of the visible image on the photosensitive drum 21, and thus the image forming position at which the visible image is transferred to the recording sheet P has been adjusted without correcting skew of the recording sheet P, the variation described below may be used alternatively. According to this variation, skew of the recording sheet P is corrected directly by adjusting the conveying velocity of the recording sheet P in the X direction.

FIG. 9 is a top view schematically showing a sheet feeding section 30 to illustrate a variation of the embodiment according to the present invention.

In FIG. 9, the registration roller 40 in FIG. 1 are replaced by two registration rollers 40a and 40b installed on both ends of the sheet feed guide 42 in the X direction. The registration roller 40a is connected with a motor 40a′ which drives it and the registration roller 40b is connected with a motor 40b′ which drives it. Normally, the motors 40a′ and 40b′ drive to rotate the registration rollers 40a and 40b with a uniform velocity.

As shown in FIG. 9, if the recording sheet P being conveyed in the sheet feed guide 42 is skewed, the adjustment section 92 controls the motors 40a′ and 40b′ based on the phase information about the recording sheet P acquired in the step S4 in FIG. 7 and conveying distance to a predetermined transfer position 50. Specifically, the adjustment section 92 determines that the recording sheet P shown in FIG. 9 is skewed due to a conveying delay caused by the registration roller 40a. Thus, the adjustment section 92 calculates the rotational velocity of the registration roller 40a needed to eliminate the conveying delay until the recording sheet P reaches the transfer position predicted in the step S5. Incidentally, a number of rotations of the motor 40a′ may be used instead of the rotational velocity of the registration roller 40a. Subsequently, the registration roller 40a rotates with higher velocity than the registration roller 40b, making X-direction adjustments so that the conveying direction of the recording sheet P is parallel to the sheet feed guide 42. Eventually, instead of the transfer position predicted in the step S5, the recording sheet P reaches the transfer position 50 adjusted in advance to the image forming position 800 (FIG. 8A) of the visible image on the photosensitive drum 21.

According to this variation, it is possible to avoid misregistration without adjusting the image forming position 800 of the visible image and transfer the visible image to the recording sheet P properly.

In the above variation, the registration roller 40 have been taken as an example, which, however, is similarly applicable to the pull-off roller pairs 36 and pre-registration roller 41.

Although in the embodiment and its variation described above, the CCD sensor 80 of the sheet phase information acquisition device 90 is disposed between the rollers 40 and 41 so as to face the sheet feed guide 42, it may be disposed in any place as long as it can photograph the recording sheet P. By disposing the CCD sensor 80 upstream of the transfer position 50 along the conveying direction, it is possible to achieve registration easily. Besides, two or more CCD sensors may be used instead of the single CCD sensor 80.

The values of speckle contrast Sc or the values of image frequency F obtained from speckles do not differ significantly among different sheets of paper provided the same type of recording sheet P (plain paper, thick paper, or the like) is used. By taking advantage of this fact, a database may be created in advance by associating the types of recording sheet P with the values of speckle contrast Sc or values of image frequency F. In that case, the copier 100 is configured to change image forming conditions according to the type of recording sheet P corresponding to the values of speckle contrast Sc or the values of image frequency F acquired from the speckles.

Furthermore, if the a recording sheet P is of a slippery type, the copier 100 may be configured to increase the rotational velocity of the pull-off roller pairs to allow for slippage of the recording sheet P during passage through the pull-off roller pairs. This makes it possible to prevent jams of the recording sheet P caused by slippage. Preferably, the user is informed of the increase in the rotational velocity of the rollers on the display screen of the operating section 4. This allows the user to change from the slippery type recording sheet P to another type of recording sheet at an early stage.

Although in the embodiment and its variation described above, the visible image is transferred from the photosensitive drum 21 to the recording sheet P, it may be formed directly on the recording sheet P without transfer to the photosensitive drum 21.

Also, although the present invention has been applied to a monochrome copier, it may be applied to a color copier. Furthermore, the present invention is not limited to image forming apparatus such as copiers, and it may be applied to a conveying apparatus such as an automatic document feeder (ADF) which conveys a sheet subject to multiple feed, skew, or rotating in a conveying path.

It is to be understood that the object of the present invention may also be accomplished by supplying a system or an apparatus with a storage medium in which a program code of software, which realizes the functions of the above described embodiment is stored, and causing a computer (or CPU or MPU) of the system or apparatus to read out and execute the program code stored in the storage medium.

In this case, the program code itself read from the storage medium realizes the functions of the embodiment described above, and hence the program code and the storage medium in which the program code is stored constitute the present invention.

Examples of the storage medium for supplying the program code include a floppy (registered trademark) disk, a hard disk, a magnetic-optical disk, an optical disk such as a CD-R, a CD-RW, a DVD-ROM, a DVD-RAM, a DVD-RW, DVD+RW, a magnetic tape, a nonvolatile memory card, and a ROM. Alternatively, the program may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-108043, filed Apr. 10, 2007, which is hereby incorporated by reference herein in its entirety.

What is claimed is:

1. An image forming apparatus, comprising:
an image forming unit adapted to form an image on a sheet being conveyed;
a light irradiation unit adapted to irradiate the sheet with a laser beam;
a scanning unit adapted to scan a pattern image generated by the irradiation of the sheet with the laser beam;
a phase information acquisition unit adapted to acquire phase information about the sheet based on the pattern image read by said scanning unit and the pattern image read after a lapse of a predetermined time, wherein
said image forming unit adjusts position of the image to be formed based on the phase information acquired by said phase information acquisition unit.

2. An image forming apparatus adapted to perform an image forming operation to form images on a sheet being conveyed, comprising:
a light irradiation unit adapted to irradiate the sheet with a laser beam;
a light intensity detection unit adapted to detect scattered light intensity of the laser beam reflected by at least part of area on a surface of the sheet;
a light intensity distribution information acquisition unit adapted to acquire light intensity distribution information about distribution of the detected light intensity in the at least part of area; and
a phase information acquisition unit adapted to acquire phase information about phases of the sheet based on the light intensity distribution information.

3. An image forming apparatus according to claim 2, wherein said phase information acquisition unit acquires displacement information about displacement of the sheet based on changes in the light intensity distribution information.

4. An image forming apparatus according to claim 3, comprising an adjustment unit adapted to adjust a forming position of an image to be formed on the sheet based on the acquired displacement information about the sheet.

5. An image forming apparatus according to claim 4, wherein said adjustment unit performs at least one of correction of the forming position of the image and rotation of the image based on a position to which the sheet is conveyed, to adjust the forming position of the image.

6. An image forming apparatus according to claim 3, comprising an adjustment unit adapted to adjust a conveying direction of the sheet based on the acquired displacement information about the sheet.

7. An image forming method for performing an image forming operation to form images on a sheet being conveyed, comprising:
a light irradiation step of irradiating the sheet with a laser beam;
a light intensity detection step of detecting scattered light intensity of the laser beam reflected by at least part of area on a surface of the sheet;
a light intensity distribution information acquisition step of acquiring light intensity distribution information about distribution of the detected light intensity in the at least part of area; and
a phase information acquisition step of acquiring phase information about phases of the sheet based on the light intensity distribution information.

8. An image forming method according to claim 7, wherein said phase information acquisition step acquires displacement information about displacement of the sheet based on changes in the light intensity distribution information.

9. An image forming method according to claim 8, comprising an adjustment step of adjusting a forming position of an image to be formed on the sheet based on the acquired displacement information about the sheet.

10. An image forming method according to claim 9, wherein said adjustment step performs at least one of correction of the forming position of the image and rotation of the image based on a position to which the sheet is conveyed, to adjust the forming position of the image.

11. An image forming method according to claim 8, comprising an adjustment step of adjusting a conveying direction of the sheet based on the acquired displacement information about the sheet.

12. A sheet conveying apparatus adapted to convey a sheet, comprising:
a light irradiation unit adapted to irradiate the sheet with a laser beam;
a light intensity detection unit adapted to detect scattered light intensity of the laser beam reflected by at least part of area on a surface of the sheet;
a light intensity distribution information acquisition unit adapted to acquire light intensity distribution information about distribution of the detected light intensity in the at least part of area; and
a phase information acquisition unit adapted to acquire phase information about phases of the sheet based on the light intensity distribution information.

13. A sheet conveying method for conveying a sheet, comprising:
a light irradiation step of irradiating the sheet with a laser beam;
a light intensity detection step of detecting scattered light intensity of the laser beam reflected by at least part of area on a surface of the sheet;
a light intensity distribution information acquisition step of acquiring light intensity distribution information about distribution of the detected light intensity in the at least part of area; and
a phase information acquisition step of acquiring phase information about phases of the sheet based on the light intensity distribution information.
